(19) United States
(12) Patent Application Publication
(10) Pub. No.: US 2023/0416504 A1
(43) Pub. Date: Dec. 28, 2023

(54) LOW DENSITY CELLULOSE BASED INSULATING LAMINATED PRODUCTS AND METHODS OF MAKING THE SAME

(71) Applicant: CLEANFIBER, LLC, Blasdell, NY (US)

(72) Inventors: Jonathan Strimling, Bedford, NH (US); Michael Bilodeau, Clermont, FL (US); Edward Donowick, Buffalo, NY (US)

(73) Assignee: CLEANFIBER INC., Blasdell, NY (US)

(21) Appl. No.: 18/252,027

(22) PCT Filed: Nov. 5, 2021
(86) PCT No.: PCT/US2021/058351

§ 371 Date: May 5, 2023

Related U.S. Application Data
(60) Provisional application No. 63/110,484, filed on Nov. 6, 2020.

(51) Int. Cl. C08L 1/02; B32B 29/02; B32B 7/12; B32B 5/02

(52) U.S. Cl. CPC C08L 1/02; B32B 29/02; B32B 7/12; B32B 5/02; C08L 2205/16; B32B 2260/046; B32B 2260/028; B32B 2553/00; B32B 2307/304; B32B 2255/12; B32B 2262/04; B32B 2307/72; B32B 2307/7265

(57) ABSTRACT

A cellulose-based laminate product including a first skin, a second skin, and a mat matrix positioned between the first skin and the second skin. The mat matrix includes a plurality of cellulosic fibers formed into agglomerations with voids contained therebetween. The plurality of cellulosic fibers may be Short Fiber Residuals alone or in combination with other fibers, including flexible organic fibers and nanocellulose fibers. The mat matrix may be formed in place between the first and second skins. The first and second skins may be treated for moisture resistance. The laminate product of the present invention can be used to provide thermal and/or impact insulation for a wide array of applications.

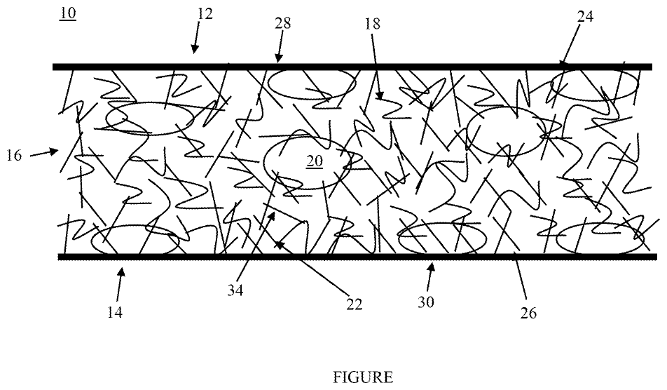

### BACKGROUND OF THE INVENTION

### 1. Field of the Invention

The present invention relates to laminated assemblies and methods of making the same. More particularly, the present invention relates to insulated laminated assemblies made of low density cellulose-based materials sandwiched between barrier components and methods of their manufacture. These low-density insulated laminated assemblies made from cellulose may be used in packaging, building insulation, and/or other applications.

### 2. DESCRIPTION OF THE PRIOR ART

Insulation packaging materials have been widely used in shipping containers to insulate the contents of the containers, including as thermal insulation and impact insulation but not limited thereto. Thermal insulation extends the period of time that perishable items remain viable, and impact insulation reduces the chance of content damage that may occur during the shipping process. For the most part, such insulation structures tend to be for one-time use and are typically discarded upon removal of the contents from the container. Unfortunately, these discarded insulation structures add to the ever-increasing volume of non-recyclable waste. It is desirable to provide effective insulation structures for container packaging that reduce the adverse environmental impact associated with existing shipment insulation products.

Given the function of insulation structures and the expansion of remote purchase of goods that must be shipped to buyers, there has been an increase in efforts to provide such insulation structures that are inexpensive and environmentally friendly. Inexpensive insulation structures that have been and continue to be used to thermally insulate and/or limit content damage primarily comprised Styrofoam pieces, plastic pillows, and paper. Each has its limitations and so more complex insulation structures have been developed, including rigid paper-based geometric structures and multilayer panels comprised of multiple materials. One example of the latter is an insulation panel having top and bottom paper-based barrier layers that sandwich an insulation core layer. The insulation core layer is formed of discrete hydrated compressed puffed carbohydrates—starch—that are chemically or mechanically joined together. See U.S. Pat. No. 10,357,936. While the concept of a multilayer insulation structure has its advantages as a packaging insulator, the incorporation of a primarily starch-based core layer renders such an insulation structure unsatisfactory. Starch has a shelf life limitation when considering the need to store packaging insulation for an indeterminate period of time in variable temperature and humidity conditions. Starch can be a relatively expensive component when the goal is to provide a cost-effective insulation structure. Starch as a primary component can also be an undesirable component for food insulation as contact with food can adversely impact the food.

What is needed is a packaging product that provides reasonable thermal and/or impact insulation characteristics to maintain the integrity of shipment contents during the shipping process. What is also needed is a packaging product that is recyclable or that at least has a reasonably short decay life if discarded as waste. Further, what is needed is a packaging product that is cost effective to produce. Yet further, what is needed is such a packaging product that does not include starch as a major component.

### SUMMARY OF THE INVENTION

It is an object of the present invention to provide a packaging product that provides reasonable thermal and/or impact insulation characteristics to maintain the integrity of shipment contents during the shipping process. It is also an object of the present invention to provide a packaging product that is recyclable or that at least has a reasonably short decay life if discarded as waste. It is a further object of the invention to provide a packaging product that is cost effective to produce. Yet another object of the present invention is to provide such a packaging product that does not include starch as a major component.

These and other objects are achieved by the present invention, which is a cellulosic-based insulated laminate product wherein the insulative portion of the product includes a cellulose mat matrix as a primary component. The mat matrix is retained between a first barrier or skin and a second barrier or skin, wherein the first skin and the second skin function as protective barrier materials. The mat matrix may be formed between the two skins or it may be formed separately and then affixed between the two skins. The mat matrix includes a plurality of cellulosic fibers and voids established among the plurality of cellulosic fibers. The mat matrix may be produced with a void fraction of at least 30%, although it is not limited thereto. The mat matrix may optionally include one or more binding agents, one or more strengthening agents, and one or more non-cellulosic materials, including natural and/or manmade materials.

The cellulosic fibers may be of a substantially uniform size or two or more distinct sizes. For example, the cellulosic fibers may include nanocellulose fibers, which are cellulose fibers with average fiber lengths between 0.4 to 0.2 millimeters, as described in US Patent Application No. 20170073893, the content of which is incorporated herein by reference. In an embodiment of the invention, the mat matrix has a combination of nanocellulose fibers and non-nanocellulose fibers. The nanocellulose fibers may function as bonding material to join cellulosic fibers together, as well as cellulosic fibers and non-cellulosic materials together. Other binding means may be employed to join fiber materials together including, but not limited to gums, carbohydrates, polyvinyl alcohol, styrene butadiene latex, styrene acrylic latex, and/or polyvinyl acetate latex.

In an embodiment of the invention, a foaming agent may be mixed with the cellulosic fibers and used to establish or aid in establishing the voids in and among agglomerations of the cellulosic fibers, as well as any optional additive materials that are not cellulosic. The optional foaming agent may be any of sodium lauryl sulfate, sodium alkyl sulfate, sodium cocoamphoacetate, gelatin, lecithin, and/or baking powder. The combination of fibers and foaming agent is warmed enough to cause the foaming agent to foam. That foam may be used to establish the voids in the mat matrix and can additional be used to join the fibers together. The choice of foaming agent and cellulose fiber size or sizes determines the extent of the voids and the size of the voids created when forming the mat matrix. For example, the void size may be in the range of 50 microns to 5 millimeters in diameter but not limited thereto. The mat matrix may have a density of the fiber insulating mat between the first and second skin that is in the range of about one to about four pounds per cubic foot. Additionally, a foaming agent may function as an adhesive that causes the fiber agglomerations to adhere to the first and second skin when the mat matrix is formed between the two skins. A bonding agent distinct from fibers may be employed to bond a preformed mat matrix between the two skins.

An array of cellulosic fiber sizes and components may be employed as part of the mat matrix. For example, Short Fiber Residuals (“SFR”) may be used alone or in combination with other cellulosic materials including, but not limited to, alternate fiber sources, obtained from other sources, such as recycled paper, corrugated cardboard, other recycled or virgin paper fiber sources and/or agricultural byproducts.

The use of SFR materials for packaging and other types of products for which relatively low density, structural integrity, environmentally safe and cost effectiveness are of interest solves two problems. For the pulp industry, it eliminates a waste stream that otherwise would need to be landfilled or trucked to a disposal site. For packaging and other products, SFR materials provide a cost-effective feedstock that eliminates the need to purchase more expensive feedstock supplies. The SFR and other types of fibers can be joined together to form the agglomerations of the mat matrix. These agglomerations can be characterized as superstructures of fibers fixedly joined together to form three-dimensional bodies. The three-dimensional bodies may be in the form of tubes, sheets, woven mats, stars or other three-dimensional configurations and any combinations thereof.

The cellulosic fiber superstructures can optionally be formed through a foaming process as described herein to be of sufficient structural integrity that they resist collapse under reasonable pressure, thereby maintaining the voids and, thus, the insulative low-density quality of the packaging product. While the use of SFR as the primary cellulosic fiber component of the mat matrix of the present invention is desirable, other cellulosic recycle feedstocks may be used instead of or in addition to SFR. These other feedstocks include, but are not limited to, Old Corrugated Container (OCC), Old Newsprint (ONP), Double Lined Kraft (DLK), other virgin or recycled kraft fiber, agricultural fiber residuals, and various other grades of fiber that may be readily procured in the open market.

The cellulose superstructures may alternatively be formed prior to the bonding, optional foaming, and/or laminating of the mat matrix and then included in the composition that is then bonded and/or foamed. The separate formation of such cellulose superstructures can be achieved by multiple methods including, but not limited to, those described in PCT patent application Publication No. WO2017/066728, published April 2017, the entire content of which is incorporated herein by reference. In that version of the mat matrix, a binder is required to join the fibers into the superstructures. The binder may be a starch, an adhesive, a polymer (specifically including a biodegradable polymer), a suspension of fine cellulose fiber (which may include the nanocellulose fibers), a flexible gum, or other substance which has the effect of binding structures together. The superstructure may additionally be formed by foaming the fiber to create voids and then drying the foamed fibers.

The first skin and the second skin of the cellulose-based product used to retain the mat matrix therebetween are barrier components of the product. The barrier components perform as airflow stops on both surfaces of the product that effectively converts the open-cell structure of the cellulose insulative material construct to a product having an effective closed-cell structure. The barrier components may be made of kraft paper, recycled paper or other type of material suitable for the intended function of the product. The first skin and the second skin may or may not be water resistant. The insulative material with cellulosic insulation is located between the first and second skins and, as noted, is retained therebetween using a binder that binds the mat matrix to the skins. Other attachment options are possible, such as by mechanical attachment but not limited thereto. The laminate formed by the combination of three components may be foldable, bendable, and/or cuttable as desired. The laminate may be rigid as an assembly (for example, for the creation of boxes) or flexible as an assembly (as may be useful to produce a foldable bag).

The insulated laminate product of the present invention with cellulosic insulation material formed of fibers that may include fiber superstructures provide an effective and cost competitive way to insulate items with environmentally suitable materials while eliminating the limitations associated with the use of starch-based voids. The cellulosic insulation material may have a density of between about one and four pounds per cubic foot. The laminate product may be configured as a build-up of multiple laminates that can be used to make batts, insulating boards or other types of cellulose-based insulative products. The laminate product of the present invention can be used for thermal and/or impact-resistance packaging, as a building material, or other applications for which an environmentally desirable insulator is of interest. As an example, a single laminate or a sandwich of laminates to make a batt with extremely high insulative performance and adequate structural integrity. The cellulose-based laminate singularly or as a sandwich of laminates could also be shredded to make a blown insulation that has an exceptionally high R value (compared to conventional cellulose) because of the closed rather than open structure established by using the barrier components.

These and other advantages of the present invention will be recognized by those of skill in the art in view of the following detailed description, the accompanying drawings, and the appended claims.

### BRIEF DESCRIPTION OF THE DRAWING

The FIGURE is a cross sectional side view representation of the cellulosic foam-based packaging product of the present invention.

### DETAILED DESCRIPTION OF THE INVENTION

The FIGURE illustrates a cellulose-based laminate product 10 of the present invention. The product 10 is a laminate including a first skin 12, a second skin 14 and a relatively low-density mat matrix 16 positioned between the first skin 12 and the second skin 14. The matrix 16 includes cellulosic fibers represented as fibers 18, which fibers 18 are integrated with voids 20. The matrix has some flexibility and give but agglomerations of the fibers 18 maintain the structural integrity of the matrix 16 so that void volume remains fairly consistent when the product 10 is in use to provide thermal insulation and/or cushioning.

The cellulose fibers 18 may be of substantially uniform length. There may be fibers 18 of a plurality of different lengths, including but not limited to fibers that are characterized as nanocellulose fibers. The fibers 18 define the structure of the matrix 16 with the voids 20 of substantially fixed or variable volume. The fibers 18 may be nanocellulose fibers, they may be SFR, and/or they may be other types of cellulose fibers that may or may not come from recyclable cellulosic materials. The fibers 18 are joined together to establish and maintain the voids 20 using one or more binders 22. The fibers 18 may themselves be the binder 22, such as a suspension of fine cellulose fibers including nanocellulose fibers that are or are a portion of the fibers 18. The binder 22 may be something other than a cellulosic fiber, such as a starch, an adhesive, a polymer (specifically including a biodegradable polymer), a suspension of fine cellulose fiber (which may include the nanocellulose fibers), a flexible gum, or other substance which has the effect of binding structures together. The binder may be any chemical, biological, or other additive designed to enhance the bonding between fibers 18. The binder 22 may also be used to join the matrix 16 to interior surfaces 24 and 26 of the first skin 12 and second skin 14.

The mat matrix 16 may be fabricated away from the first skin 12 and the second skin 14 and then bonded in place between the first skin 12 and the second skin 14. Alternatively, the mat matrix 16 may be formed in place between the first skin 12 and the second skin 14, or it may be formed in place on the interior surface of one of the skins, through foaming or other methods, and cured in place and then the other skin bonded to the mat matrix 16 so formed.

Either or both of the first skin 12 and the second skin 14, as well as the mat matrix 16, may be formed into configurations of the product 10 including, but not limited to, rigid corrugated containers, flexible packaging liners, cushioning including seat cushioning, and flexible bags.

The mat matrix 16 is formed by joining the fibers 18 together in a way that establishes voids therebetween. The fibers may be combined with one or more other components including for example, one or more of a binding agent, a strengthening agent, and other additives that may be of interest including, but not limited to, natural and manmade materials, that together establish selectable desirable characteristics of the product 10. The binding agent may be as indicated herein. In an embodiment of the invention in which the fibers 18 are at least partially combined together, a binding agent is a foaming agent that may be sodium lauryl sulfate, sodium alkyl sulfate, sodium cocoamphoacetate, gelatin, lecithin, baking powder.

The combination of components used to product the mat matrix 16 is initially in a liquid form such as a colloidal suspension that may include water as an agent of fiber suspension. The fibers 18 in the suspension may be SFR or other cellulose fiber residuals. The fibers 18 may be the only solid component of the suspension or they may be interspersed with other materials in the suspension, such as other recyclable cellulosic materials including, but not limited to, OCC and ONP. In addition, other additives may be included in the suspension, such as relatively more flexible organic fibers such as cotton, for example. The cellulose fiber-based suspension may be mechanically or enzymatically treated to hydrate, swell, and increase the bonding potential of the cellulosic material. These treatments can be used to improve the bond strength of the fibers 18 including any nanocellulose fibers that may function as the binder 22 in addition to the structure for maintaining the voids 20.

In one option for making the mat matrix 16, the suspension is placed in a mold with a foaming agent and heated until the foaming agent produces gas that becomes trapped among the fibers 18 to form the voids 20. That heating also cures the solids to bind the fibers 18 into agglomerations that establish and maintain the voids 20. That heating may produce off gassing, such as steam, that should be vented from the mold. Heating may be conducted using microwaves. Once curing has been completed or during the curing process, the formed mat matrix 16 may be bonded in place between the first skin 12 and the second skin 18 to produce the sandwich that is the product 10. The mat matrix 16 made this way may be formed as a long web of extended length that can be cut to selectable size before insertion between the two skins. The foam may be generated by using a trapped gas as the foaming agent, extruding the suspension under pressure, and then reducing that pressure to allow the trapped gas to expand. Alternatively, the foaming agent may be a liquid such as water that is heated to its boiling point to generate gas that is at least partially trapped by the curing agglomeration of cellulose fibers 18.

In another option for making the mat matrix 16, the suspension including a foaming agent is placed on the interior surface 24/26 of either the first skin 12 or the second skin 14, with some sort of retaining frame placed about its perimeter. The suspension is then heated until the foaming agent produces the gas that becomes trapped among the fibers 18 to form the voids 20, and the fibers 18 are bound into agglomerations that establish and maintain the voids 20. Once curing is complete, the perimeter frame can then be removed and the other of the two skins bonded to the exposed surface of the mat matrix 16 to produce the sandwich that is the product 10. This option may also be used to make a long web of extended length that may be cut to selectable size.

In yet another option, the suspension including a foaming agent is placed on the interior surface 24/26 of either the first skin 12 or the second skin 14, and the other of the two skins applied to the upper surface of the suspension. A retaining frame may be used on the perimeter of this lamination to keep the suspension in place. The suspension is then heated until the foaming agent produces the gas that becomes trapped among the fibers 18 to form the voids 20, and the fibers 18 are bound into agglomerations that establish and maintain the voids 20. Once curing is complete, the perimeter frame can then be removed. The resultant web can be made of any extended length and cut to a selectable size. In this version of making the product 10, the skins 12 and 14 may be perforated to allow any gaseous material resulting from the foam curing process to vent through the skins 12 and 14. The perforations of the skins 12 and 14 may then be sealed on exterior surfaces 28 and 30, such as by bonding with a nonporous barrier including paper, for example.

It is to be noted that the processes described above for making the product 10 can be used to form and bind the mat matrix 16 without using a foaming agent. For example, voids can be created in the suspension by mixing it and then the suspension is cured into the mat matrix 16 while the mixed-in voids remain trapped between the bonded fibers 18.

Either or both of the first skin 12 and the second skin 14 may be treated on either or both of the interior surfaces 20 and 22, as well as either or both of exterior surfaces 26 and 28, with a moisture resistant coating, such as natural or synthetic wax, wood rosin, alkenyl succinic anhydride (ASA), alkyl ketene dimer (AKD) sizing agents, or other suitable material that may be a recyclable material.

It is to be understood that various modifications may be made to the cellulose-based laminate product 10 and its individual components without departing from the spirit and scope of the invention provided such variants include fiber superstructures as part of the insulative material. In particular, it should be understood that any reference to the use of SFR as a primary component of the mat matrix could be equally well applied to other materials including cellulosic fibers and combinations thereof that are established as superstructures, including other fiber residuals with similar properties from other sources. All equivalents are deemed to fall within the scope of this description of the invention as identified by the following claims.

1. A cellulose-based laminate product comprising:
a first skin;
a second skin; and
a cellulose-based mat matrix positioned between the first skin and the second skin, wherein the mat matrix includes a plurality of cellulosic fibers, wherein at least a portion of the plurality of fibers are joined together to form agglomerations that establish voids therebetween in the mat matrix.

2. The laminate product of claim 1 further comprising a binder for securing the mat matrix between the first skin and the second skin.

3. The laminate product of claim 2 further comprising a second binder for joining at least a portion of the plurality of cellulosic fibers together to form the agglomerations.

4. The laminate product of claim 3 wherein at least a portion of the plurality of cellulosic fibers is nanocellulose fibers.

5. (canceled)

6. The laminate product of claim 4 wherein at least a portion of the nanocellulose fibers comprise the second binder for joining at least a portion of the plurality of cellulosic fibers together to form the agglomerations.

7. The laminate product of claim 1 wherein at least a portion of the plurality of cellulosic fibers is obtained from Short Fiber Residuals (SFR).

8. (canceled)

9. (canceled)

10. The laminate product of claim 1 wherein the first skin and the second skin are formed of paper.

11. The laminate product of claim 10 wherein the first skin and the second skin are treated with a moisture resistance coating.

12. (canceled)

13. (canceled)

14. The laminate product of claim 1 wherein a plurality of combinations of the first skin, the mat matrix and the second skin are sandwiched together.

15. A mat matrix comprising a plurality of cellulosic fibers, wherein at least a portion of the plurality of fibers are joined together to form agglomerations that establish voids therebetween.

16. The mat matrix of claim 15 wherein at least a portion of the plurality of cellulosic fibers is nanocellulose fibers.

17. The mat matrix of claim 16 wherein at least a portion of the nanocellulose fibers comprise a binder for joining at least a portion of the plurality of cellulosic fibers together to form the agglomerations.

18. The mat matrix of claim 15 wherein at least a portion of the plurality of cellulosic fibers is obtained from Short Fiber Residuals (SFR).

19. (canceled)

20. (canceled)

21. The mat matrix of claim 15 having a density in a range of about one to about four pounds per cubic foot.

22. A method of making a cellulose-based laminate product including a first skin, a second skin and a mat matrix between the first skin and the second skin, wherein the mat matrix includes a plurality of cellulosic fibers and voids therein, the method comprising the steps of:
generating a suspension including the plurality of cellulosic fibers and a foaming agent;
heating the suspension to create the voids from the foaming agent and to bond at least a portion of the plurality of cellulosic fibers together to form agglomerations that retain the voids therein and thereby establish the mat matrix; and
bonding the mat matrix between the first skin and the second skin.

23. The method of claim 22 wherein the heating is accomplished by microwave.

24. (canceled)

25. (canceled)

26. The method of claim 25 wherein a portion of the plurality of cellulosic fibers is nanocellulose fibers and at least a portion of the nanocellulose fibers are the binding agent.

27. The method of claim 22 further comprising the steps of:
perforating the first skin and the second skin to make perforations therethrough;
inserting the suspension between the perforated first skin and second skin;
venting off gassing from the suspension through the perforations during the step of heating the suspension; and
over skinning the first skin and the second skin with non-perforated skins after formation of the mat matrix.

28. The method of claim 22 further comprising the steps of:
placing the suspension on the first skin, wherein the first skin is not perforated;
placing the second skin over the suspension, wherein the second skin is perforated to form perforations therethrough;
venting off gassing from the suspension through the perforations of the second skin during the step of heating the suspension; and
over skinning the second skin with a non-perforated second skin after formation of the mat matrix.

29. (canceled)

30. The method of claim 22 wherein the foaming agent is a trapped gas that expands when the suspension is heated.

31. (canceled)
